(19) United States
(12) Patent Application Publication
(10) Pub. No.: US 2013/0159016 A1
(43) Pub. Date: Jun. 20, 2013

(54) AUTOMATED ADMISSION

(71) Applicants: Ahmed ALI, Doha (QA); Kareem Darwish, Doha (QA)

(72) Inventors: Ahmed ALI, Doha (QA); Kareem Darwish, Doha (QA)

(73) Assignee: Qatar Foundatiion, Doha (QA)

(21) Appl. No.: 13/370,097

(22) Filed: Feb. 9, 2012

(30) Foreign Application Priority Data
Dec. 16, 2011 (GB) 1121636.3

(51) Int. Cl. G06Q 50/22; G06Q 50/24

(52) U.S. Cl. 705/3; 705/2

(57) ABSTRACT

A computer-implemented method and system for providing automated admission to a healthcare unit for a potential patient, comprising receiving patient data from the potential patient at a server via a communications module of a mobile terminal, processing the patient data to determine a level of care required, updating an admission support module of a healthcare unit on the basis of the determined level of care, displaying a notification on a display of the mobile terminal representing an instruction for the potential patient.

### CROSS REFERENCE TO RELATED APPLICATIONS

This application claims foreign priority from UK Patent Application Serial No. 1121636.3, filed 16 Dec. 2011.

### BACKGROUND

Systems and procedures for providing healthcare advice to a user who may be remote from a healthcare professional or unit exist. Typically, such systems enable a user to contact a healthcare professional in a different location in order to seek advice or receive instructions on how to perform certain tasks associated with an injury or ailment which they or another person may be suffering from. Similar systems in which a user can receive health information, either on an ad-hoc or frequent basis using, for example the short messaging service of a cellular network are also known.

Other systems which enable a user to select a suitable healthcare unit exist. For example, increasing numbers of people are opting for selection of convenient care units for treatment of medical conditions requiring non-emergency or non-urgent care. In systems which allow users to select a unit, multiple factors can be taken into account in order to provide a user with a listing of suitable healthcare professionals or units from which one can be selected.

### SUMMARY

According to an example, there is provided a computer-implemented method for providing automated admission to a healthcare unit for a potential patient, comprising receiving patient data from the potential patient at a server via a communications module of a mobile terminal, processing the patient data to determine a level of care required, updating an admission support module of a healthcare unit on the basis of the determined level of care, displaying a notification on a display of the mobile terminal representing an instruction for the potential patient. Medial data for the potential patient can be received from a remote healthcare database on the basis of the patient data. Receiving medical data can include querying the healthcare database to determine a record for the potential patient. An instruction for the potential patient can include a direction to the healthcare unit. A sensor can be used to determine a measure for one or more user conditions such as temperature and blood pressure, and a measure can be used to augment data the patient data.

According to an example, there is provided a system for providing automated admission to a healthcare unit for a potential patient, comprising a mobile terminal to receive input data from a user representing a current state of their wellbeing, a processor of the mobile terminal to process the input data, a server to receive data from the mobile terminal using a communications module thereof, and an admission support module of a healthcare unit to receive admission data representing a level of care derived from the data. The admission support module can receive medial data for the potential patient from a remote healthcare database. The admission support module can query the healthcare database to determine a record for the potential patient. The mobile terminal can display an instruction for the potential patient which includes directions to a healthcare unit. The system can further comprise a sensor to determine a measure for one or more user conditions such as temperature and blood pressure and can generate condition data representing the or each condition. The mobile terminal can augment data input by a user with condition data.

### BRIEF DESCRIPTION OF THE DRAWINGS

An embodiment of the invention will now be described, by way of example only, and with reference to the accompanying drawings, in which:

FIG. 1 is a schematic block diagram of a device according to an example;

FIG. 2 is a schematic block diagram of a method according to an example;

FIG. 3 is a flowchart of a method according to an example; and

FIG. 4 is a schematic block diagram of a system according to an example.

### DETAILED DESCRIPTION

It will be understood that, although the terms first, second, etc. may be used herein to describe various elements, these elements should not be limited by these terms. These terms are only used to distinguish one element from another. For example, a first gesture could be termed a second gesture, and, similarly, a second gesture could be termed a first gesture.

The terminology used herein is for the purpose of describing particular examples only and is not intended to be limiting. As used herein, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

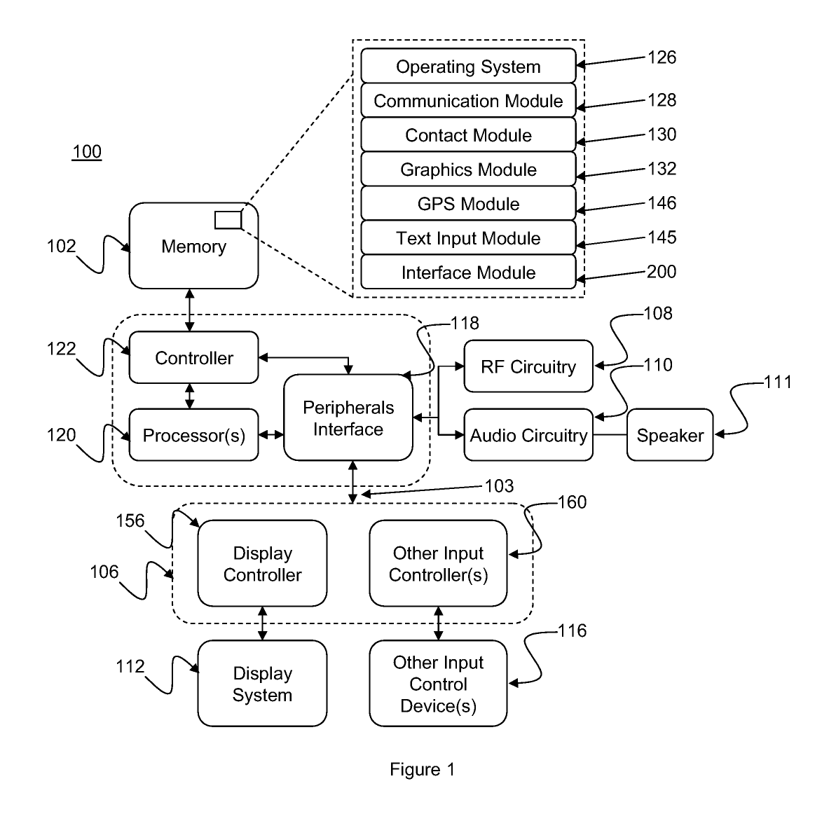

FIG. 1 is a schematic block diagram of a device 100 according to an example. Device 100 can be a mobile terminal such as a mobile telephone or smart phone for example. In other examples, device 100 can be a PDA or tablet computing device. Other alternatives are possible.

In some examples, the device 100 includes a touch-sensitive display system 112. The touch-sensitive display system 112 is sometimes called a “touch screen” for convenience. In other examples, display system 112 can include a non-touch sensitive display such as an LCD or LED display for example. The device 100 may include a memory 102 (which may include one or more computer readable storage mediums), a memory controller 122, one or more processing units (CPU's) 120, a peripherals interface 118, RF circuitry 108, audio circuitry 110, a speaker 111, an input/output (I/O) subsystem 106 and other input or control devices 116. These components may communicate over one or more communication buses or signal lines 103.

It should be appreciated that the device 100 is only one example of a device 100, and that the device 100 may have more or fewer components than shown in FIG. 1, may combine two or more components, or may have a different configuration or arrangement of the components than that shown. The various components shown in FIG. 1 may be implemented in hardware, software or a combination of both hardware and software, including one or more signal processing and/or application specific integrated circuits for example.

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of machine readable instructions stored in memory 102 to perform various functions for the device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, an intranet and/or a wireless network, such as a cellular telephone network, a wireless local area network (LAN), and other devices by wireless communication. The wireless communication may use any of a plurality of communications standards, protocols and technologies.

The audio circuitry 110 and the speaker 111 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. Audio data may be retrieved from and/or transmitted to memory 102 and/or the RF circuitry 108 by the peripherals interface 118. In some examples, the audio circuitry 110 also includes a headset jack. The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, trackpads, touch interface devices and so forth. In some alternate embodiments, input controller(s) 160 may be coupled to any (or none) of the following: a keyboard, infrared port, USB port, and a pointer device such as a mouse. The one or more buttons may include an up/down button for volume control of the speaker 111. The one or more buttons may include a push button or slider control. The touch screen 112 can be used to implement virtual or soft buttons or other control elements and modules for a user interface for example.

The touch-sensitive touch screen 112 can provide an input interface and an output interface between the device and a user. The display controller 156 receives and/or sends electrical signals from/to the touch screen 112. The touch screen 112 displays visual output to the user. The visual output may include graphics, text, icons, video, and any combination thereof. In some embodiments, some or all of the visual output may correspond to user-interface objects, further details of which are described below.

A touch screen 112 can include a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects that are displayed on the touch screen or another display device. In an example, a point of contact between a touch screen 112 and the user corresponds to a finger of the user.

The touch screen 112 and the display controller 156 may detect contact and any movement or breaking thereof using any of a plurality of typical touch sensing technologies, including but not limited to capacitive, resistive, infrared, and surface acoustic wave technologies, as well as other proximity sensor arrays or other elements for determining one or more points of contact with a touch screen 112.

In some example, software components stored in memory 102 may include an operating system 126, a communication module (or set of instructions) 128, a contact module (or set of instructions) 130, a graphics module (or set of instructions) 132, a GPS module 146 and a text input module 145.

The communication module 128 facilitates communication with other devices over one or more external ports (not shown). The contact/motion module 130 may detect contact with the touch screen 112 (in conjunction with the display controller 156) and other touch sensitive devices (e.g., a touchpad or physical click wheel). The contact module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., multiple finger contacts).

The graphics module 132 includes various known software components for rendering and displaying graphics on the touch screen 112, including components for changing the intensity of graphics that are displayed. As used herein, the term “graphics” includes any object that can be displayed to a user, including without limitation text, icons (such as user-interface objects), digital images, videos, animations and the like.

The GPS module 146 can determine the location of the device 100 and provide this information for use in various applications (e.g., for use in location-based dialing, for a camera etc. The GPS module 146 can determine the current location of the device 100 for use in determining a route from the current location to a desired destination.

The text input module 145, which may be a component of graphics module 132, can provide a soft keyboard for entering text in various applications for the device 100. For example, a soft keyboard can be used by a user to provide textual input relating to answers to questions posed to the user, such as questions relating to the current state of health of the user, or for the determination of other information which can be used to verify or authenticate the user so that information for or about them can be provided and/or retrieved.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module). In some examples, memory 102 may store a subset of the modules and data structures identified above. Furthermore, memory 102 may store additional modules and data structures not described above.

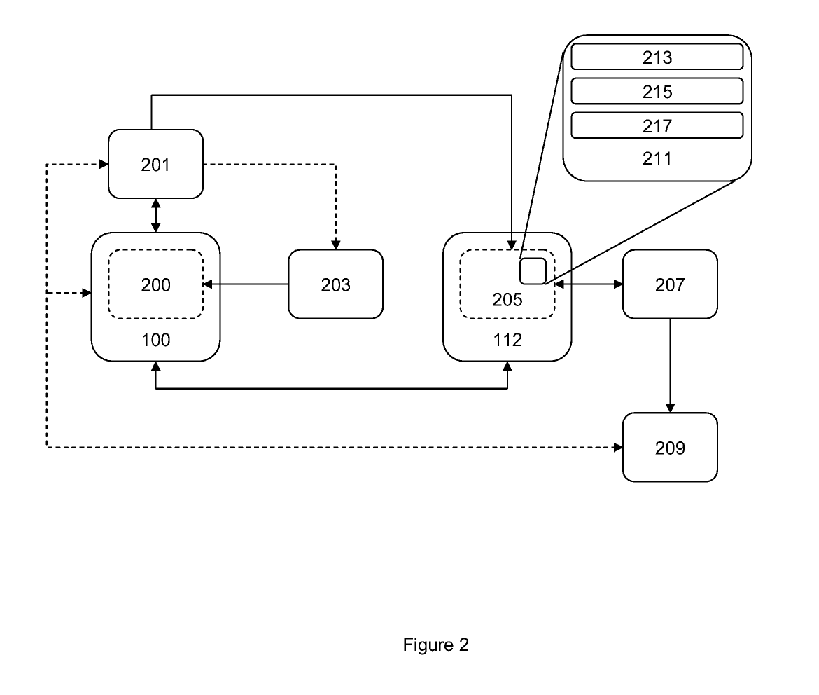

FIG. 2 is a schematic block diagram of a method according to an example. A user 201 such as a potential patient uses a device 100. Device 100 can include a standalone application or functionality for the provision of automated admission of the user to a healthcare unit. For example, referring also to FIG. 1, device 100 can include an interface module 200. Module 200 can be a user interface which allows a user to input data to device 100 which represents a current state of health or wellbeing for the user 201 and which can include other input data such as patient data representing identification or medical information for the user 201.

In an example, a user can execute an application on device 100 which launches interface module 200 thereby allowing the user to input data to device 100 and receive information, such as information provided by a remote source. In block 203, an interface module 200 is executed on a device 100. The module 200 can be executed by the user selecting an appropriate function or command of device 100, such as my selecting an appropriate command using touch screen system 112 for example. The interface module 200 can cause a graphical user interface 205 to be displayed on display system 112. A user can be prompted to enter certain data 207 via the GUI 205. For example, data 207 can be in the form of patient data which can include data representing an identification of the user 201 such as their name, address, telephone number and/or any other unique identifier such as a medical reference identification number for example. Other data will also be provided as a result of the user being prompted to answer questions such as their personal information, ranking pain being experienced according to some range, previous symptoms, or whether they are allergic to any medicine and so on.

In an example, the patient data can be forwarded from device 100, such as over a wireless communication channel using a communications module of device 100 such as RF circuitry 108 for example to a server 209. Server 209 can be a server which includes data representing multiple individuals. Server 209 can be located at a healthcare unit for example. Alternatively, the server 209 can be part of a cloud based storage computing infrastructure. The server 209 can verify the identity of user 201 by issuing a challenge to them which can be responded to using device 100 as is typical. The patient data can be provided to the server 209 in encrypted form. In an example, the patient data can be hashed with data which can be based on an identifier associated with the device 100 or user input data.

In an example, patient data 207 includes data representing a current condition of the user 201. That is, GUI 205 can include questions or other prompts which solicit information from the user 201 in order to provide a representation of a current condition for the user 201. The questions or prompts can be geared to provide a basic triage process or can be more sophisticated so that a specific illness or injury can be determined with a certain degree of accuracy. In an example, answers to questions can be provided to server 209. Alternatively, the answers can be processed in device 100 in order to provide a diagnosis which can be provided to server 209. A confidence score associated with a diagnosis can be calculated which can provide a measure for the accuracy of the diagnosis on the basis of the answers received or made. For example, a user can enter a confidence score associated with each of their answers, such as a score ranging from one to ten for example, with one representing relatively less confidence in the user's answer and a score of ten representing relatively more confidence in the user's answer. Other alternatives are possible, such as a sliding scale interface element present on the GUI for example which can be translated to a numerical score by a CPU of device 100.

Block 211 represents a typical GUI element which can be used to solicit information from a user 201 and which includes a representation that allows the user to accord a confidence score to their answer. For example, a question can be provided in block 213, and answer input box in block 215, and a confidence score block 217 can be provided. In another example, a confidence score may not be provided, and the user's answers may be taken at face value.

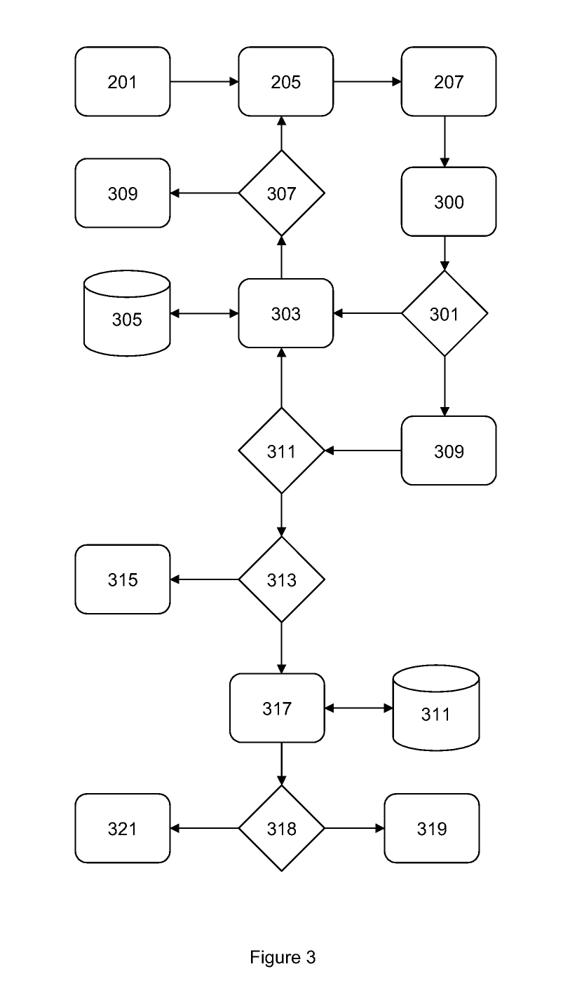

FIG. 3 is a schematic block diagram of a method according to an example. A user 201 who is a potential patient for a healthcare unit uses the GUI 205 to input data 207 representing information about their current condition and in response to questions posed via the GUI 205. In an example, GUI 205 therefore represents an application interface for determining data 207 to help in responding to a user's (actual or perceived) requirement for help.

Data 207 is provided to a reception module 300 where a determination can be made as to whether more information is required in order to be able to help the user 201. For example, if missing, incomplete, inaccurate or inconsistent answers are provided by the user via GUI 205, this can be determined in block 300. If it is determined that more information is required in block 301, a data collection and analysis module 303 can be queried. The module 303 is in communication with a regional healthcare system database 305. Accordingly, patient data can be provided via the module 303 in order to query the database 305 so that missing or incomplete information for the user 201 can be obtained. Data received from the database 305 can be analysed by module 303. In the event that such a query has resulted in a determination that insufficient information is available in block 307, the GUI 205 can prompt the user 201 to rectify the situation by inputting more data 207 for example. If sufficient information is available, or if no further data was required in block 301, the data is provided to block 309.

In block 309 the data collected from user 201 and, if needed, database 305 is summarised. For example, collected data can be arranged into a specific format as required by a healthcare unit, and which places the collected data into a required structure. This may highlight the need to populate certain parts of the structure with additional data from the user 201, and the user can be prompted accordingly if the additional data is not available from a remote healthcare server, such as 305 for example. If it is determined in block 311 that more information is needed, the module 303 can be queried again as described above. If no more information is needed a determination is made in block 313 as to whether admission of user 201 into a healthcare unit is required. If no, the database 305 is updated accordingly in block 315. If yes, an admission support unit of a healthcare unit is notified in block 317. The healthcare unit can have access to a regional hospital database 311 in order to retrieve and provide information related to the user 201. If the admission support unit determines that an ambulance for example is required in block 318, an ambulance can be despatched in block 319 and provided with GPS information from device 100 to provide a location of user 201. If no ambulance is required in block 318, instructions can be sent to the user 201 via device 100 in block 321. The instructions can include information on what the user should do, what steps they should take and/or where they should go in order to be dealt with, and can be in the form of a user notification for example.

At decision points in the path of the method as outlined in FIG. 3, such as points 307, 311, 313 and so on, a determination can be made which can be automatic, use human intervention or a combination of the two. For example, an intelligent decision support system that can use Machine Learning and/or assisted human intervention to help in a decision making process can be used.

In an example, a device 100 can include sensors, which can be integral to the device or standalone sensors which are operatively coupled to the device 100, either over a wired or wireless link such as a radio frequency or optical communication link for example. The sensors can include devices to measure a user's blood pressure and temperature for example, and the results of the measurements can be used to augment or otherwise provide the required data in block 207. Alternatively, device 100 can receive data from a remote location relating to temperature, blood pressure etc which has been measured suing sensors which are not operatively coupled to the device. For example, if the user had the blood pressure measured earlier that day in a healthcare facility, that measurement can be provided, for example, if no other sensor is available for use. The fact that the measurement is an ‘old’, i.e. not immediately up to date, value can be flagged and used as part of the process for determining if the user requires attention.

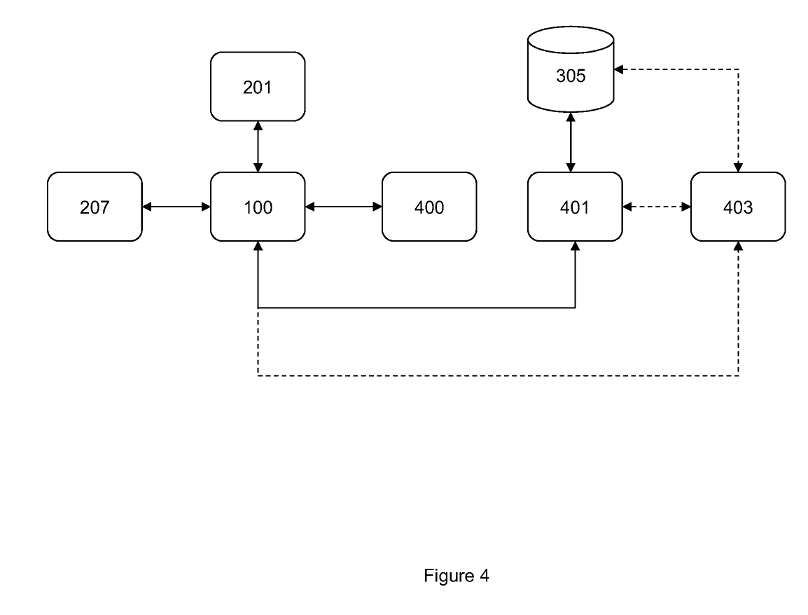

FIG. 4 is a schematic block diagram of a system according to an example. Device 100 is operatively coupled to one or more sensors 400 which can determine and measure a biological condition of a user, such as a temperature and/or blood pressure for example. The data from sensor(s) 400 can be used to provide or augment the data 207. Collected data can be automatically compared against a template 401 in order to determine if there are any gaps or any areas where additional information may be required (because, for example, the collected data is less than an average template quantity). In an example, multiple templates may be stored on a remote server, such as healthcare database 305, such that data which has been collected can be compared against multiple templates, or against one which may have been pre-selected as a result of a user's past medical history for example.

In an example, a trained human operator 403 can be on-hand to intervene should any data which has either been provided by a user, determined as required, or provided by a healthcare database does not conform to a required format or level of completeness. The operator can request information from a user or from a healthcare database 305, and provide or otherwise augment data for the system.

For example, if a user is suffering from chest pain a few weeks after having had a major heart operation, the system can automatically categorise this as a severe condition which requires the user to be seen by doctor immediately, so in this case the system will make a decision with high confidence that the patient must be seen by doctor immediately. Alternatively, another user suffering from chest pain who has never had any problems before and who is young for example with no family history of heart conditions will likely result in the system referring to the human operator 403 to ask for more information. Accordingly, if enough information can be provided by a user and a healthcare database such that a decision can be made with a reasonable degree of confidence, then the system can proceed automatically. Otherwise, if the confidence level is lower than a threshold, human assistance will be required. A threshold relating to a degree of confidence can be predetermined based on a template 401 for example. That is, a comparison tool such as a template which is designed to measure the completeness and/or accuracy of collected data can have an associated threshold which may be in the form of a multiple threshold values which vary depending on the completeness or level of detail of collected data for specific questions. That is, some questions may be more critical than others and may therefore contribute more to an overall threshold value than a less critical question and so on.

What is claimed is:

1. A computer-implemented method for providing automated admission to a healthcare unit for a potential patient, comprising:
receiving patient data from the potential patient at a server via a communications module of a mobile terminal;
processing the patient data to determine a level of care required;
updating an admission support module of a healthcare unit on the basis of the determined level of care;
displaying a notification on a display of the mobile terminal representing an instruction for the potential patient.

2. A computer-implemented method as claimed in claim 1, further comprising receiving medial data for the potential patient from a remote healthcare database on the basis of the patient data.

3. A computer-implemented method as claimed in claim 2, wherein receiving medical data includes querying the healthcare database to determine a record for the potential patient.

4. A computer-implemented method as claimed in claim 1, wherein the instruction for the potential patient includes directions to the healthcare unit.

5. A computer-implemented method as claimed in claim 1, further comprising:
using a sensor to determine a measure for one or more user conditions such as temperature and blood pressure;
using a measure to augment data the patient data.

6. A system for providing automated admission to a healthcare unit for a potential patient, comprising:
a mobile terminal to receive input data from a user representing a current state of their wellbeing;
a processor of the mobile terminal to process the input data;
a server to receive data from the mobile terminal using a communications module thereof; and
an admission support module of a healthcare unit to receive admission data representing a level of care derived from the data.

7. A system as claimed in claim 6, the admission support module to receive medial data for the potential patient from a remote healthcare database.

8. A system as claimed in claim 7, the admission support module to query the healthcare database to determine a record for the potential patient.

9. A system as claimed in claim 6, the mobile terminal to display an instruction for the potential patient which includes directions to a healthcare unit.

10. A system as claimed in claim 6, further comprising:
a sensor to determine a measure for one or more user conditions such as temperature and blood pressure and to generated condition data representing the or each condition.

11. A system as claimed in claim 10, the mobile terminal to augment data input by a user with condition data.
